(19) United States
(12) Patent Application Publication
(10) Pub. No.: US 2020/0150773 A1
(43) Pub. Date: May 14, 2020

(54) ELECTRONIC DEVICE WHICH PROVIDES VOICE RECOGNITION SERVICE TRIGGERED BY GESTURE AND METHOD OF OPERATING THE SAME

(71) Applicant: SAMSUNG ELECTRONICS CO., LTD., SUWON-SI (KR)

(72) Inventors: JUNG-HA SON, HWASEONG-SI (KR); EMHWAN KIM, YONGIN-SI (KR); JUNGSU KIM, YONGIN-SI (KR); JIN-WON BAEK, HWASEONG-SI (KR)

(21) Appl. No.: 16/541,585

(22) Filed: Aug. 15, 2019

(30) Foreign Application Priority Data
Nov. 12, 2018 (KR) 10-2018-0138250

(51) Int. Cl. G06F 3/01; G06F 3/16

(52) U.S. Cl. CPC G06F 3/017; G06F 3/167; G06F 3/011

(57) ABSTRACT

An electronic device includes a memory storing a gesture recognition program and a voice trigger program, a dynamic vision sensor, a processor, and a communication interface. The dynamic vision sensor detects an event corresponding to a change of light caused by motion of an object. The processor is configured to execute the gesture recognition program to determine whether a gesture of the object is recognized based on timestamp values output from the dynamic vision sensor, and execute the voice trigger program in response to the gesture being recognized. The communication interface is configured to transmit a request for a voice recognition service corresponding to the gesture to a server in response to the voice trigger program being executed.

### CROSS-REFERENCE TO RELATED APPLICATIONS

This application claims priority under 35 U.S.C. § 119 to Korean Patent Application No. 10-2018-0138250 filed on Nov. 12, 2018 in the Korean Intellectual Property Office, the disclosure of which is incorporated by reference herein in its entirety.

### TECHNICAL FIELD

Exemplary embodiments of the present disclosure described herein relate to an electronic device, and more particularly, relate to an electronic device that provides a voice recognition service triggered by a user's gesture.

### DISCUSSION OF THE RELATED ART

Electronic devices, such as a smart speaker that provides an artificial intelligence based voice recognition service, are becoming more ubiquitous. Generally, a voice triggering method based on detecting the voice of a user input through a microphone is widely used to implement the voice recognition service. However, the voice triggering method needs to call the same wakeup word every time the voice recognition service is used, which can become inconvenient for the user. In addition, the quality of the voice recognition service may be degraded in a noisy environment.

A CMOS image sensor (CIS) is widely used to recognize a user's gesture. Since the CIS outputs the image information of not only a moving object, but also of a stationary object, the amount of information to be processed in gesture recognition may increase rapidly. Moreover, gesture recognition using the CIS may violate the privacy of a user, and capturing images using the CIS may require a significant amount of current. Furthermore, the recognition rate may decrease at a low intensity of illumination.

### SUMMARY

Exemplary embodiments of the present disclosure provide an electronic device that provides a voice recognition service triggered by the gesture of a user.

According to an exemplary embodiment, an electronic device includes a memory storing a gesture recognition program and a voice trigger program, a dynamic vision sensor, a processor, and a communication interface. The dynamic vision sensor detects an event corresponding to a change of light caused by motion of an object. The processor is configured to execute the gesture recognition program to determine whether a gesture of the object is recognized based on timestamp values output from the dynamic vision sensor, and execute the voice trigger program in response to the gesture being recognized. The communication interface is configured to transmit a request for a voice recognition service corresponding to the gesture to a server in response to the voice trigger program being executed.

According to an exemplary embodiment, a method of operating an electronic device includes detecting, by a dynamic vision sensor, an event corresponding to a change of light caused by motion of an object, and determining, by a processor, whether a gesture of the object is recognized based on timestamp values output from the dynamic vision sensor. The method further includes triggering, by the processor and in response to recognizing the gesture, a voice trigger program, as well as transmitting, by a communication interface, a request for a voice recognition service corresponding to the gesture to a server in response to the voice trigger program being triggered.

According to an exemplary embodiment, a computer program product includes a computer-readable storage medium having program instructions embodied therewith. The program instructions are executable by a processor to cause the processor to control a dynamic vision sensor configured to detect an event corresponding to a change of light caused by motion of an object, determine whether a gesture of the object is recognized based on timestamp values output from the dynamic vision sensor, execute a voice trigger program in response to the gesture being recognized, and transmit a request for a voice recognition service corresponding to the gesture to a server in response to the voice trigger program being executed.

### BRIEF DESCRIPTION OF THE DRAWINGS

The above and other features of the present disclosure will become more apparent by describing in detail exemplary embodiments thereof with reference to the accompanying drawings, in which:

FIG. 1 is a diagram illustrating an electronic device according to an exemplary embodiment of the present disclosure.

FIG. 2 is a block diagram of a program module driven in the electronic device of FIG. 1;

FIG. 3 illustrates an exemplary configuration of the DVS illustrated in FIG. 1.

FIG. 4 is a circuit diagram illustrating an exemplary configuration of a pixel constituting the pixel array of FIG. 3.

FIG. 5 illustrates an exemplary format of information output from the DVS illustrated in FIG. 3.

FIG. 6 illustrates exemplary timestamp values output from a DVS;

FIG. 7 illustrates an electronic device according to an exemplary embodiment of the present disclosure.

FIG. 8 is a flowchart illustrating a method of operating an electronic device according to an exemplary embodiment of the present disclosure.

FIG. 9 is a flowchart illustrating a method of operating an electronic device according to an exemplary embodiment of the present disclosure.

FIG. 10 is a diagram illustrating an electronic device according to an exemplary embodiment of the present disclosure.

FIG. 11 is a flowchart illustrating a method of operating an electronic device according to an exemplary embodiment of the present disclosure.

FIG. 12 is a flowchart illustrating a method of operating an electronic device according to an exemplary embodiment of the present disclosure.

### DETAILED DESCRIPTION

Exemplary embodiments of the present disclosure will be described more fully hereinafter with reference to the accompanying drawings. Like reference numerals may refer to like elements throughout the accompanying drawings.

Components described herein with reference to terms “part”, “unit”, “module”, “engine”, etc., and function blocks illustrated in the drawings, may be implemented with software, hardware, or a combination thereof. In an exemplary embodiment, the software may be a machine code, firmware, an embedded code, and application software. The hardware may include, for example, an electrical circuit, an electronic circuit, a processor, a computer, an integrated circuit, integrated circuit cores, a pressure sensor, an inertial sensor, a microelectromechanical system (MEMS), a passive element, or a combination thereof.

Exemplary embodiments of the present disclosure provide an electronic device capable of providing an improved voice recognition service having improved accuracy and reduced data throughput, thus providing an improved electronic device in terms of both performance and reliability.

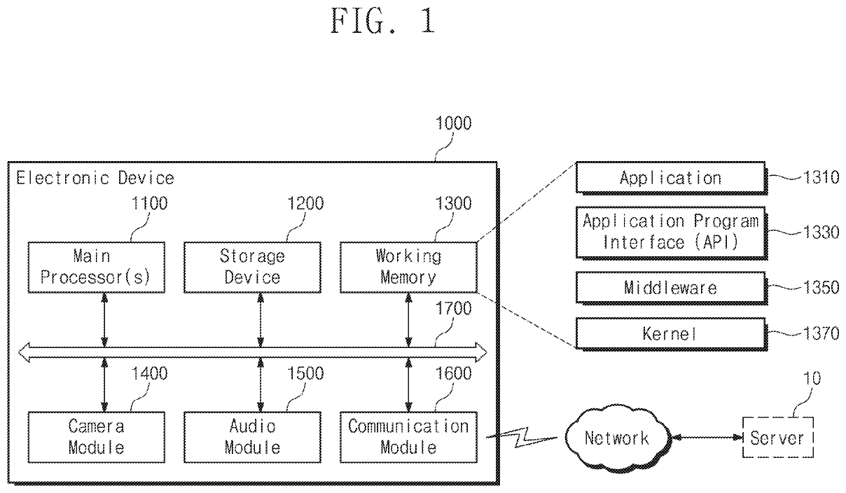

FIG. 1 illustrates an electronic device according to an exemplary embodiment of the present disclosure.

An electronic device 1000 may include a main processor 1100, a storage device 1200, a working memory 1300, a camera module 1400, an audio module 1500, a communication module 1600, and a bus 1700. The communication module 1600 may be, for example, a communication circuit that transmits and receives data via a wired and/or wireless interface. The communication module 1600 may also be referred to herein as a communication interface. The electronic device 1000 may be, for example, a desktop computer, a laptop computer, a tablet, a smartphone, a wearable device, a smart speaker, a home security device including an Internet of Things (JOT) device, a video game console, a workstation, a server, an autonomous vehicle, etc.

The main processor 1100 may control overall operations of the electronic device 1000. For example, the main processor 1100 may process various kinds of arithmetic operations and/or logical operations. To this end, the main processor 1100 may be implemented with, for example, a general-purpose processor, a dedicated or special-purpose processor, or an application processor, which includes one or more processor cores.

The storage device 1200 may store data regardless of whether power is supplied. The storage device 1200 may store programs, software, firmware, etc. necessary to operate the electronic device 1000. For example, the storage device 1200 may include at least one nonvolatile memory device such as a flash memory, a phase-change RAM (PRAM), a magneto-resistive RAM (MRAM), a resistive RAM (ReRAM), a ferroelectric RAM (FRAM), etc. For example, the storage device 1200 may include a storage medium such as a solid state drive (SSD), removable storage, embedded storage, etc.

The working memory 1300 may store data used for an operation of the electronic device 1000. The working memory 1300 may temporarily store data processed or to be processed by the main processor 1100. The working memory 1300 may include, for example, a volatile memory, such as a dynamic random access memory (DRAM) a synchronous DRAM (SDRAM), etc., and/or a nonvolatile memory, such as a PRAM, an MRAM, a ReRAM, an FRAM, etc.

In an exemplary embodiment, programs, software, firmware, etc. may be loaded from the storage device 1200 to the working memory 1300, and the loaded programs, software, firmware, etc. may be driven by the main processor 1100. The loaded program, software, firmware, etc. may include, for example, an application 1310, an application program interface (API) 1330, middleware 1350, and a kernel 1370. At least a part of the API 1330, the middleware 1350, or the kernel 1370 may be referred to as an operating system (OS).

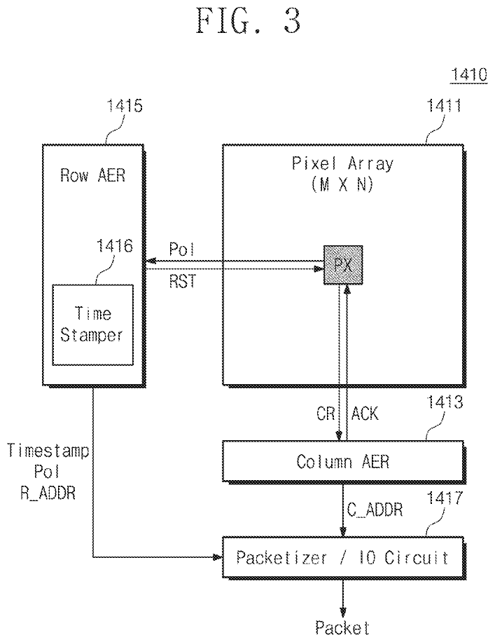

The camera module 1400 may capture a still image or a video of an object. The camera module 1400 may include, for example, a lens, an image signal processor (ISP), a dynamic vision sensor (DVS), a complementary metal-oxide semiconductor image sensor (CIS), etc. The DVS may include a plurality of pixels and at least one circuit controlling the pixels, as described further with reference to FIG. 3. The DVS may detect an event corresponding to a change of light (e.g., a change in intensity of light) caused by motion of an object, as described in further detail below.

The audio module 1500 may detect sound to convert the sound into an electrical signal or may convert the electrical signal into sound to provide a user with the sound. The audio module 1500 may include, for example, a speaker, an earphone, a microphone, etc.

The communication module 1600 may support at least one of various wireless/wired communication protocols for communicating with an external device/system of the electronic device 1000. For example, the communication module 1600 may be a wired and/or wireless interface. For example, the communication module 1600 may connect a server 10 configured to provide the user with a cloud-based service (e.g., an artificial intelligence-based voice recognition service) to the electronic device 1000.

The bus 1700 may provide a communication path between the components of the electronic device 1000. The components of the electronic device 1000 may exchange data with each other in compliance with a bus format of the bus 1700. For example, the bus 1700 may support one or more of various interface protocols such as Peripheral Component Interconnect Express (PCIe), Nonvolatile Memory Express (NVMe), Universal Flash Storage (UFS), Serial Advanced Technology Attachment (SATA), Small Computer System Interface (SCSI), Serial Attached SCSI (SAS), Generation-Z (Gen-Z), Cache Coherent Interconnect for Accelerators (CCIX), Open Coherent Accelerator Processor Interface (OpenCAPI), etc.

In an exemplary embodiment, the electronic device 1000 may be implemented to perform voice triggering based on gesture recognition. For example, the electronic device 1000 may recognize the gesture of a user by using the DVS of the camera module 1400 and may trigger the voice recognition service driven in the server 10 based on the recognized gesture. For example, the electronic device 1000 may first recognize a visual gesture provided by the user, and may then subsequently initiate the voice recognition service to receive audible input from the user in response to recognizing the visual gesture.

Furthermore, the electronic device 1000 may be implemented to perform voice triggering based on voice recognition. For example, the electronic device 1000 may recognize the voice of a user by using the microphone of the audio module 1500 and may trigger the voice recognition service driven in the server 10 based on the recognized voice. For example, the electronic device 1000 may first recognize the voice of a specific user, and may then subsequently initiate the voice recognition service to receive audible input from the user in response to recognizing the voice.

According to these exemplary embodiments, when triggering the voice recognition service, malfunctioning of the voice recognition service may be reduced by using the DVS, which requires a relatively small amount of information processing. In addition, since a voice recognition service is triggered in combination with gesture recognition and voice recognition in exemplary embodiments, the security of the electronic device 1000 may be improved.

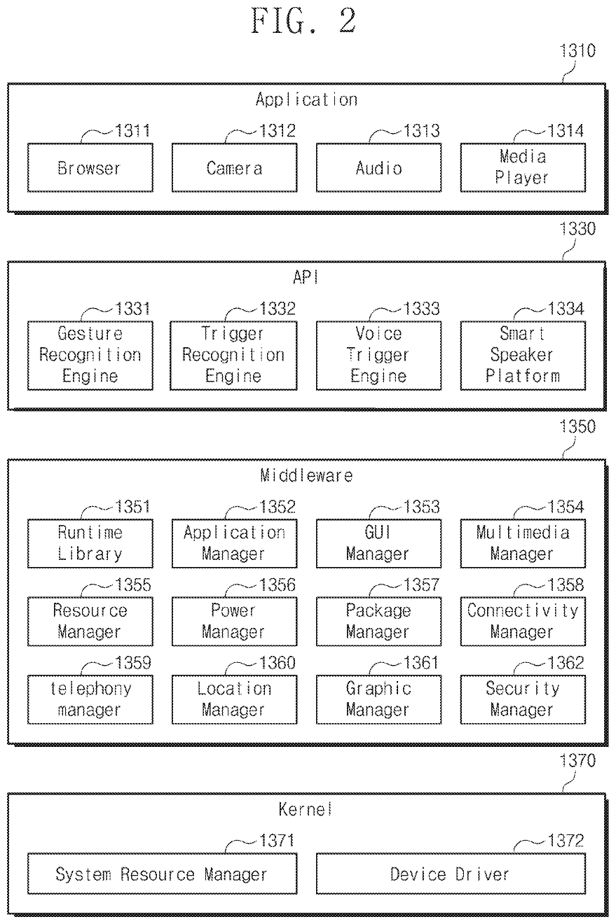

FIG. 2 is a block diagram of a program module driven in the electronic device of FIG. 1. An exemplary embodiment of the present disclosure will be described hereinafter with reference to FIGS. 1 and 2.

The program module may include the application(s) 1310, the API(s) 1330, the middleware 1350, and the kernel 1370. The program module may be loaded from the storage device 1200 to the working memory 1300 of FIG. 1 or may be downloaded from an external device and then loaded into the working memory 1300.

The application 1310 may be one of a plurality of applications capable of performing functions such as, for example, a browser 1311, a camera application 1312, an audio application 1313, a media player 1314, etc.

The API 1330 may be the set of API programming functions, and may include an interface for the application 1310 to control the function provided by the kernel 1370 or the middleware 1350. For example, the API 1330 may include at least one interface or function (e.g., instruction) for performing file control, window control, image processing, etc. The API 1330 may include, for example, a gesture recognition engine 1331, a trigger recognition engine 1332, a voice trigger engine 1333, and a smart speaker platform 1334. The gesture recognition engine 1331, the trigger recognition engine 1332, and the voice trigger engine 1333 may respectively be computer programs loaded into the working memory 1300 and executed by the main processor 1100 to perform the functions of the respective engines, as described below. According to exemplary embodiments, these computer engines/programs may be included in a single computer engine/program, or separated into different computer engines/programs.

The gesture recognition engine 1331 may recognize the gesture of a user based on the detection by the DVS or CIS of the camera module 1400. According to an exemplary embodiment of the present disclosure, the gesture recognition engine 1331 recognizes a specific gesture based on timestamp values corresponding to the user's gesture sensed through the DVS of the electronic device 1000. For example, the gesture recognition engine 1331 recognizes that the user's gesture is a gesture corresponding to a specific command, based on the specific change pattern and the direction of the change of the other timestamp values according to the user's gesture.

When the user's input through the various input devices of the electronic device 1000 is detected, the trigger recognition engine 1332 may determine whether the condition for activating the voice recognition service is satisfied. In an exemplary embodiment, when a user's voice is input through the microphone of the electronic device 1000, the trigger recognition engine 1332 determines whether the activation condition of the voice recognition service is satisfied based on, for example, a specific word, the arrangement of specific words, a phrase, etc.

In an exemplary embodiment, when the gesture of a user is detected through the DVS of the electronic device 1000, the trigger recognition engine 1332 determines whether the activation condition of the voice recognition service is satisfied based on, for example, the specific change pattern, change direction, etc. of the timestamp values. In an exemplary embodiment, the functionality of the trigger recognition engine 1332 may be included in the voice trigger engine 1333. In an exemplary embodiment, the functionality of one or more of the gesture recognition engine 1331, the trigger recognition engine 1332 and the voice trigger engine 1333 may be combined in a single engine/program. That is, in exemplary embodiments, certain functionality of these various engines/programs may be combined into a single engine/program.

The voice trigger engine 1333 may trigger the specific command of the voice recognition service based on the smart speaker platform 1334. The voice recognition service may be provided to the user via the external server 10. The triggered commands may be transmitted to the external server 10 in various formats. For example, the triggered commands may be transmitted to the external server 10 in an open standard format such as, but not limited to, JavaScript Object Notation (JSON).

The smart speaker platform 1334 provides an overall environment for providing the user with a voice recognition service of artificial intelligence based on the external server 10. In an exemplary embodiment, the smart speaker platform 1334 may be a computer-readable medium or the like including, for example, firmware, software, and program code for providing a voice recognition service, which are installed in the electronic device 1000. For example, the electronic device 1000 may be a smart speaker, and the smart speaker platform 1334 may be an environment that includes the trigger recognition engine 1332 and the voice trigger engine 1333.

The middleware 1350 may serve as an intermediary such that the API 1330 or the application 1310 communicates with the kernel 1370. The middleware 1350 may process one or more task requests received from the application 1310. For example, the middleware 1350 may assign the priority for using a system resource (e.g., the main processor 1100, the working memory 1300, the bus 1700, etc.) of the electronic device 1000 to at least one of applications. The middleware 1350 may perform scheduling, load balancing, etc. on the one or more task requests by processing the one or more work requests in order of the assigned priority.

In an exemplary embodiment, the middleware 1350 may include at least one of a runtime library 1351, an application manager 1352, a graphical user interface (GUI) manager 1353, a multimedia manager 1354, a resource manager 1355, a power manager 1356, a package manager 1357, a connectivity manager 1358, a telephony manager 1359, a location manager 1360, a graphic manager 1361, and a security manager 1362.

The runtime library 1351 may include a library module, which is used by a compiler, to add a new function through a programming language while the application 1310 is executed. The runtime library 1351 may perform input/output management, memory management, or capacities about arithmetic functions.

The application manager 1352 may manage a life cycle of the illustratively shown applications 1311 to 1314. The GUI manager 1353 may manage GUI resources used in the display of the electronic device 1000. The multimedia manager 1354 may manage formats necessary to play media files of various types, and may perform encoding and/or decoding on media files by using a codec suitable for the corresponding format.

The resource manager 1355 may manage the source code of the illustratively shown applications 1311 to 1314 and resources associated with a storage space. The power manager 1356 may manage the battery and power of the electronic device 1000, and may manage power information or the like necessary for the operation of the electronic device 1000. The package manager 1357 may manage the installation or update of an application provided in the form of a package file from the outside. The connectivity manager 1358 may manage wireless connection such as, for example, Wi-Fi, BLUETOOTH, etc.

The telephony manager 1359 may manage the voice call function and/or the video call function of the electronic device 1000. The location manager 1360 may manage the location information of the electronic device 1000. The graphic manager 1361 may manage the graphic effect and/or the user interface provided to the display. The security manager 1362 may manage the security function associated with the electronic device 1000 and/or the security function necessary for user authentication.

The kernel 1370 may include a system resource manager 1371 and/or a device driver 1372.

The system resource manager 1371 may manage, allocate, and retrieve the resources of the electronic device 1000. The system resource manager 1371 may manage system resources (e.g., the main processor 1100, the working memory 1300, the bus 1700, etc.) used to perform operations or functions implemented in the application 1310, the API 1330, and/or the middleware 1350. The system resource manager 1371 may provide an interface capable of controlling or managing system resources by accessing the components of the electronic device 1000 by using the application 1310, the API 1330, and/or the middleware 1350.

The device driver 1372 may include, for example, a display driver, a camera driver, an audio driver, a BLUETOOTH driver, a memory driver, a USB driver, a keypad driver, a Wi-Fi driver, and an Inter-Process Communication (IPC) driver.

FIG. 3 illustrates an exemplary configuration of the DVS illustrated in FIG. 1.

A DVS 1410 may include a pixel array 1411, a column address event representation (AER) circuit 1413, a row AER circuit 1415, and a packetizer and input/output (IO) circuit 1417. The DVS 1410 may detect an event (hereinafter referred to as ‘event’) in which the intensity of light changes, and may output a value corresponding to the event. For example, an event may mainly occur in the outline of a moving object. For example, when the event is a user waving his or her hand, the event may mainly occur at the outline of the user's moving hand. Unlike a general CMOS image sensor, since the DVS 1410 outputs only the value corresponding to light of which intensity is changing, the amount of data processed may be reduced greatly.

The pixel array 1411 may include a plurality of pixels PXs arranged in a matrix form along M rows and N columns, in which M and N are positive integers. A pixel from among a plurality of pixels of the pixel array 1411 which senses an event may transmit a column request (CR) to the column AER circuit 1413. The column request CR indicates that an event in which the intensity of light increases or decreases occurs.

The column AER circuit 1413 may transmit an acknowledge signal ACK to the pixel in response to the column request CR received from the pixel sensing the event. The pixel that receives the acknowledge signal ACK may output polarity information Pol of the occurring event to the row AER circuit 1415. The column AER circuit 1413 may generate a column address C_ADDR of the pixel sensing the event based on the column request CR received from the pixel sensing the event.

The row AER circuit 1415 may receive the polarity information Pol from the pixel sensing the event. The row AER circuit 1415 may generate a timestamp including information about a time when the event occurs based on the polarity information Pol. In an exemplary embodiment, the timestamp may be generated by a time stamper 1416 provided in the row AER circuit 1415. For example, the time stamper 1416 may be implemented by using a timetick generated per every several to tens of microseconds. The row AER circuit 1415 may transmit the reset signal RST to the pixel at which the event occurs in response to the polarity information Pol. The reset signal RST may reset the pixel at which the event occurs. In addition, the row AER circuit 1415 may generate a row address R_ADDR of the pixel at which the event occurs.

The row AER circuit 1415 may control a period in which the reset signal RST is generated. For example, to prevent a workload from increasing due to occurrence of a lot of events, the row AER circuit 1415 may control a period when the reset signal RST is generated, such that an event does not occur during a specific period. That is, the row AER circuit 1415 may control a refractory period of occurrence of the event.

The packetizer and IO circuit 1417 may generate a packet based on the timestamp, the column address C_ADDR, the row address R_ADDR, and the polarity information Pol. The packetizer and IO circuit 1417 may add a header indicating the start of a packet to the front of the packet and a tail indicating the end of the packet to the rear of the packet.

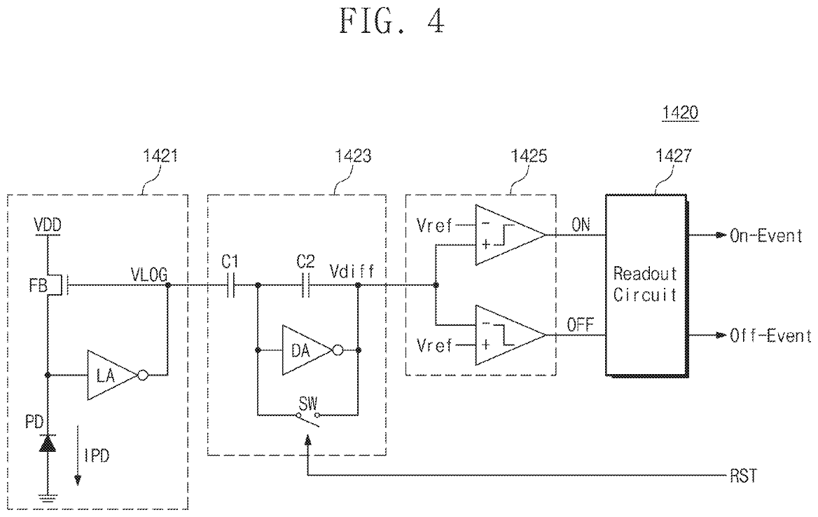

FIG. 4 is a circuit diagram illustrating an exemplary configuration of a pixel constituting the pixel array of FIG. 3.

A pixel 1420 may include a photoreceptor 1421, a differentiator 1423, a comparator 1425, and a readout circuit 1427.

The photoreceptor 1421 may include a photodiode PD that converts light energy into electrical energy, a log amplifier LA that amplifies the voltage corresponding to a photo current IPD to output the log voltage VLOG of the log scale, and a feedback transistor FB that isolates the photoreceptor 1421 from the differentiator 1423.

The differentiator 1423 may be configured to amplify the voltage VLOG to generate a voltage Vdiff. For example, the differentiator 1423 may include capacitors C1 and C2, a differential amplifier DA, and a switch SW operated by the reset signal RST. For example, each of the capacitors C1 and C2 may store electrical energy generated by the photodiode PD. For example, the capacitances of the capacitors C1 and C2 may be appropriately selected in consideration of the shortest time (e.g., a refractory period) between two events that occur consecutively at one pixel. When the switch SW is turned on by the reset signal RST, the pixel may be initialized. The reset signal RST may be received from a row AER circuit (e.g., 1415 in FIG. 3).

The comparator 1425 may compare a level of an output voltage Vdiff of the differential amplifier DA with a level of a reference voltage Vref to determine whether an event sensed from the pixel is an on-event or an off-event. For example, when an event in which the intensity of light increases is sensed, the comparator 1425 may output a signal ON indicating the on-event. When an event in which the intensity of light decreases is sensed, the comparator 1425 may output a signal OFF indicating the off-event.

The readout circuit 1427 may transmit information about an event occurring at the pixel (e.g., information indicating whether the event is an on-event or an off-event). On-event information or off-event information may be referred to as “polarity information” Pol of FIG. 3. The polarity information may be transmitted to the row AER circuit.

It is to be understood that the configuration of the pixel illustrated in FIG. 4 is exemplary, and the present disclosure is not limited thereto. For example, exemplary embodiments may be applied to DVS pixels of various configurations configured to detect the changing intensity of light to generate information corresponding to the detected intensity.

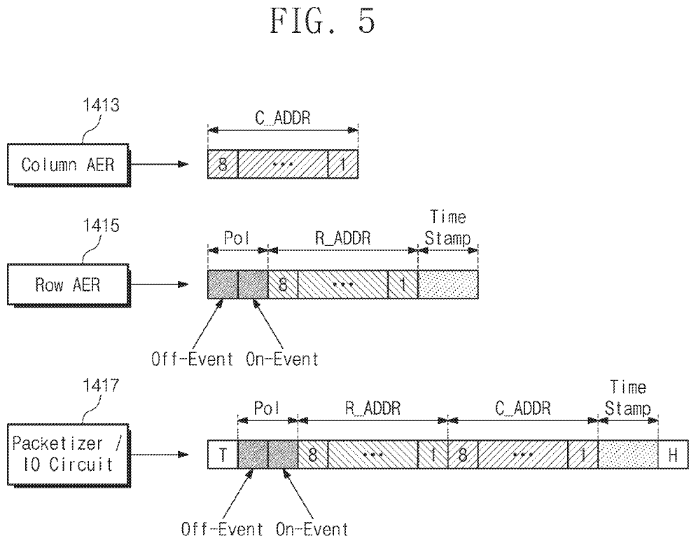

FIG. 5 illustrates an exemplary format of information output from the DVS illustrated in FIG. 3. An exemplary embodiment of the present disclosure will be given hereinafter with reference to FIGS. 3 and 5.

The timestamp may include information about a time when an event occurs. The timestamp may be, for example, 32 bits. However, the timestamp is not limited thereto.

Each of the column address C_ADDR and the row address R_ADDR may be 8 bits. Therefore, the DVS including a plurality of pixels arranged in eight rows and eight columns maximally may be supported. However, it is to be understood that this is only exemplary, and that the number of bits of the column address C_ADDR and the number of bits of the row address R_ADDR may be variously determined according to the number of pixels.

The polarity information Pol may include information about an on-event and an off-event. For example, the polarity information Pol may be formed of one bit including information about whether an on-event occurs and one bit including information about whether an off-event occurs. For example, both the bit including information about whether an on-event occurs and the bit including information about whether an off-event occurs may not be “1”, but may be “0”.

A packet may include the timestamp, the column address C_ADDR, the row address R_ADDR, and the polarity information Pol. The packet may be output from the packetizer and TO circuit 1417. Furthermore, the packet may further include a header and a tail for distinguishing one event from another event.

The gesture recognition engine (e.g., 1331 in FIG. 2) according to an exemplary embodiment of the present disclosure may recognize the user's gesture based on the timestamp, the addresses C_ADDR and R_ADDR, and the polarity information Pol of the packet, which are output from the DVS 1410, as described in further detail below.

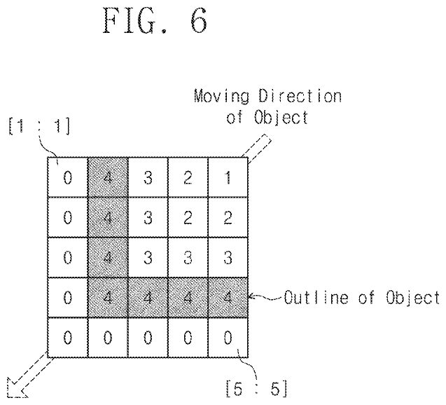

FIG. 6 illustrates exemplary timestamp values output from a DVS.

For convenience of illustration, 5×5 pixels composed of 5 rows and 5 columns are illustrated in FIG. 6. The pixel arranged in the first row and the first column is indicated as [1:1], and the pixel arranged in the fifth row and the fifth column is indicated as [5:5].

Referring to FIG. 6, the pixel of [1:5] represents ‘1’. Each of the pixels of [1:4], [2:4] and [2:5] represents ‘2’. Each of the pixels of [1:3], [2:3], [3:3], [3:4], and [3:5] represents 3. Each of the pixels of [1:2], [2:2], [3:2], [4:2], [4:3], [4:4], and [4:5] represents ‘4’. Pixels indicated as ‘0’ indicate that no event has occurred.

Since the timestamp value includes information about the time at which the event occurs, the timestamp of a relatively small value represents an event occurring relatively early. Alternatively, a timestamp of a relatively large value indicates an event occurring relatively late. Accordingly, the timestamp values illustrated in FIG. 6 may have been caused by objects moving from the right top to the left bottom. Moreover, considering the timestamp values indicated as ‘4’, it is understood that an object has a rectangular corner. For example, the pixels having the value of 4 form an outline of an object, in which it can be seen that the object has a rectangular corner.

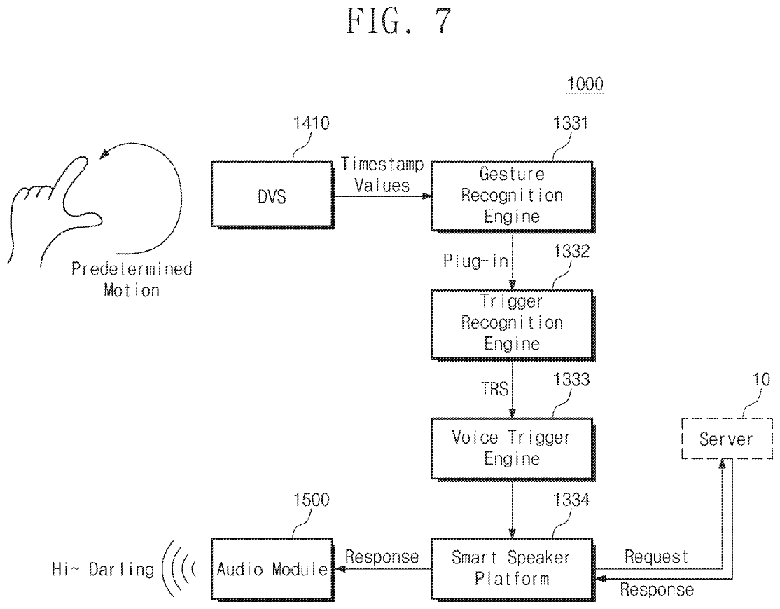

FIG. 7 illustrates an electronic device according to an exemplary embodiment of the present disclosure.

A DVS 1410 may detect the motion of a user to generate timestamp values. Because the only events detected by the DVS 1410 are events in which the intensity of light varies, the DVS 1410 may generate the timestamp values corresponding to the outline of an object (e.g., a user's hand). The timestamp values may be stored, for example, in the working memory 1300 of FIG. 1 in the form of a packet or may be stored in a separate buffer memory for processing by the image signal processor of the DVS 1410.

The gesture recognition engine 1331 may recognize the gesture based on the timestamp values provided by the DVS 1410. For example, the gesture recognition engine 1331 may recognize gestures based on the direction, speed, and pattern, at which timestamp values are changing. For example, referring to FIG. 7, since the user's hand moves counterclockwise, the timestamp values may also have values that increase in a counterclockwise manner based on the motion of the user's hand. For example, referring to the exemplary timestamp illustrated in FIG. 6 as an example, another exemplary timestamp in a scenario in which the user's hand moves counterclockwise may include values in positions indicating counterclockwise movement. The gesture recognition engine 1331 may recognize the gesture of the hand moving counterclockwise based on the timestamp values with values that increase counterclockwise.

In an exemplary embodiment, the user's gesture recognized by the gesture recognition engine 1331 may have a predetermined pattern as a predetermined gesture associated with a specific command for executing a voice recognition service. For example, the hand's gesture moving clockwise or in up, down, left, right, and zigzag directions may be recognized by the gesture recognition engine 1331 in addition to the hand's gesture moving counterclockwise illustrated in the present disclosure. In exemplary embodiments, each of these predetermined gestures may correspond to different functions to be triggered at the electronic device 1000.

However, in an exemplary embodiment, in a specific case, the voice recognition service may be triggered and executed even by a random gesture of the user. For example, when a relatively simple gesture is required, such as when a voice recognition service is first activated, the voice recognition service may be started even by a random gesture. For example, when the present disclosure is applied to a home security IoT device, the voice recognition service may be started in the form of a warning message for providing a notification of an intrusion if the intruder's movement is detected by the DVS 1410.

The trigger recognition engine 1332 may determine whether the gesture of the user satisfies the activation condition of the voice recognition service based on, for example, the change pattern, the change direction, etc. of the timestamp values having values increasing counterclockwise. For example, when the change pattern, the change direction, the change speed, etc. of the timestamp values satisfies the trigger recognition condition, the trigger recognition engine 1332 may generate the trigger recognition signal TRS.

Furthermore, the trigger recognition engine 1332 may be plugged into/connected to the voice trigger engine 1333. The voice trigger engine 1333 may originally trigger a voice recognition service based on the voice received through the audio module 1500. However, according to an exemplary embodiment of the present disclosure, the voice trigger engine 1333 may instead be triggered by the gesture sensed by the DVS 1410.

The voice trigger engine 1333 may trigger the specific command of the voice recognition service based on the smart speaker platform 1334 in response to the trigger recognition signal TRS. For example, the triggered command may be transmitted to the external server 10 as a request with an open standard format such as JSON.

The server 10 may provide the electronic device 1000 with a response corresponding to the request in response to the request from the electronic device 1000. The smart speaker platform 1334 may provide the user with a message corresponding to the received response via the audio module 1500.

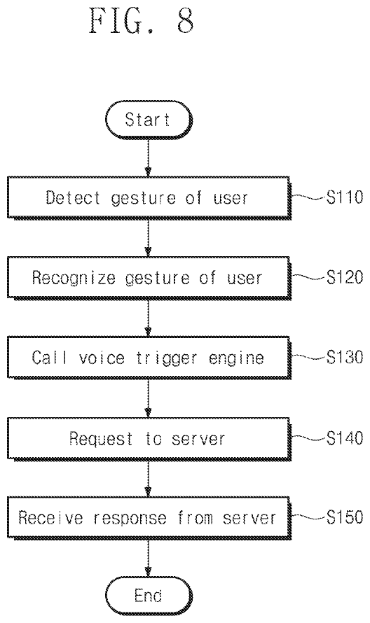

FIG. 8 is a flowchart illustrating a method of operating an electronic device according to an exemplary embodiment of the present disclosure. An exemplary embodiment of the present disclosure will be described hereinafter with reference to FIGS. 7 and 8.

In operation S110, the motion of a user is detected by the DVS 1410. The DVS 1410 may detect an event in which the intensity of light changes and may generate a timestamp value corresponding to a time at which the event occurs. For example, the DVS 1410 may generate a timestamp value indicating a time corresponding to the detected change in intensity of light. Since the event mainly occurs in the outline of an object, the amount of data generated by the DVS may be greatly reduced compared to a general CIS.

In operation S120, the motion of a user is detected by the gesture recognition engine 1331. For example, the gesture recognition engine 1331 may recognize a user's specific gesture based on a specific change pattern, change direction, etc. of the timestamp values received from the DVS 1410. That is, in operation S120, the gesture detected in operation S110 is analyzed by the gesture recognition engine 1331 to determine whether the detected gesture is a recognized gesture. In FIG. 8, it is assumed that the gesture detected in operation S110 is determined to be a recognized gesture in operation S120.

In operation S130, the voice trigger engine 1333 may be called (or invoked) by the trigger recognition engine 1332 in response to the detected gesture being determined to be a recognized gesture. For example, since the gesture recognition engine 1331 is plugged into/connected to the trigger recognition engine 1332, the trigger recognition engine 1332 may be triggered by the gesture of the user and the voice trigger engine 1333 may be called by the trigger recognition signal TRS.

In operation S140, the request to the server 10, according to the user's gesture, may be transmitted. For example, the request to the server 10 may include a specific command corresponding to a user's gesture, and may have an open standard format such as JSON. For example, the request to the server 10 may be performed through the communication module 1600 of FIG. 1. Afterward, the server 10 performs processing to provide a voice recognition service corresponding to the user's request. For example, upon the user's gesture being recognized, a request for the voice recognition service corresponding to the specific command corresponding to the recognized gesture is transmitted to the server 10.

In operation S150, a response may be received from the server 10. The response may have an open standard format such as JSON, and the voice recognition service may be provided to the user via the audio module 1500.

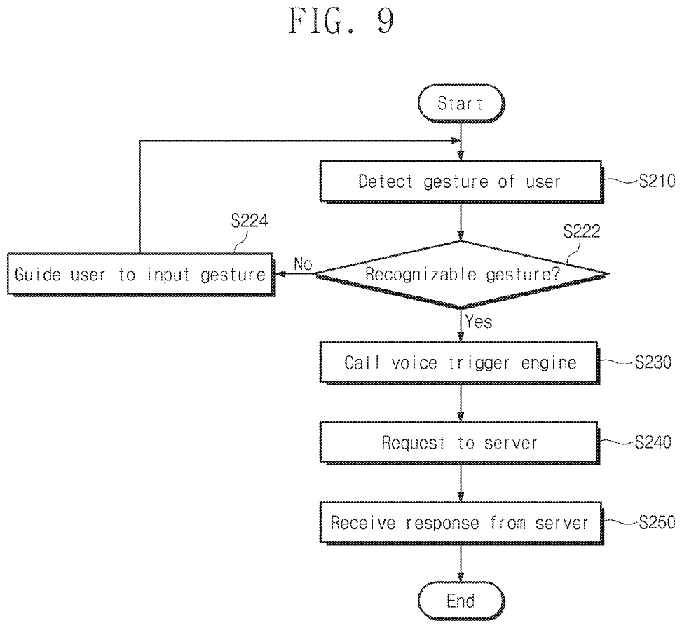

FIG. 9 is a flowchart illustrating a method of operating an electronic device according to an exemplary embodiment of the present disclosure. The exemplary embodiment of FIG. 9 is substantially similar to the exemplary embodiment of FIG. 8. For convenience of explanation, the description of FIG. 9 below will focus primarily on the differences relative to the exemplary embodiment of FIG. 8. Hereinafter, an exemplary embodiment will be described with reference to FIGS. 7 and 9.

After the DVS 1410 detects the gesture of a user in operation S210, in operation S222, the gesture recognition engine 1331 analyzes the detected gesture to determine whether the gesture is a recognized/recognizable gesture that is capable of triggering the trigger recognition engine 1332. When the detected gesture is a recognized/recognizable gesture capable of triggering the trigger recognition engine 1332 (Yes in operation S222), the procedure of calling the voice trigger engine 1333 in operation S230, transmitting a request according to the gesture to the server 10 in operation S240, and receiving a response for providing a voice recognition service corresponding to the request of the user from the server 10 in operation S250 may be performed. These operations are respectively similar to operations S130, S140 and S150 described with reference to FIG. 8.

Alternatively, when the detected gesture is not a recognized/recognizable gesture capable of triggering the trigger recognition engine 1332 (No in operation S222), the trigger recognition engine 1332 may request the middleware 1350 of FIG. 2 to detect a gesture again. For example, the middleware 1350 may guide a user to enter a gesture again on the display of an electronic device through the GUI manager 1353, the graphic manager 1361, etc. at the request of the trigger recognition engine 1332. The guide provided to the user may be, for example, a message, an image, etc. displayed on the display. However, the present disclosure is not limited thereto. For example, in an exemplary embodiment, the guide may be a voice provided by a speaker.

The user may make the gesture again depending on the guide provided by the electronic device, and operation S210 and operations after operation S210 will be performed again.

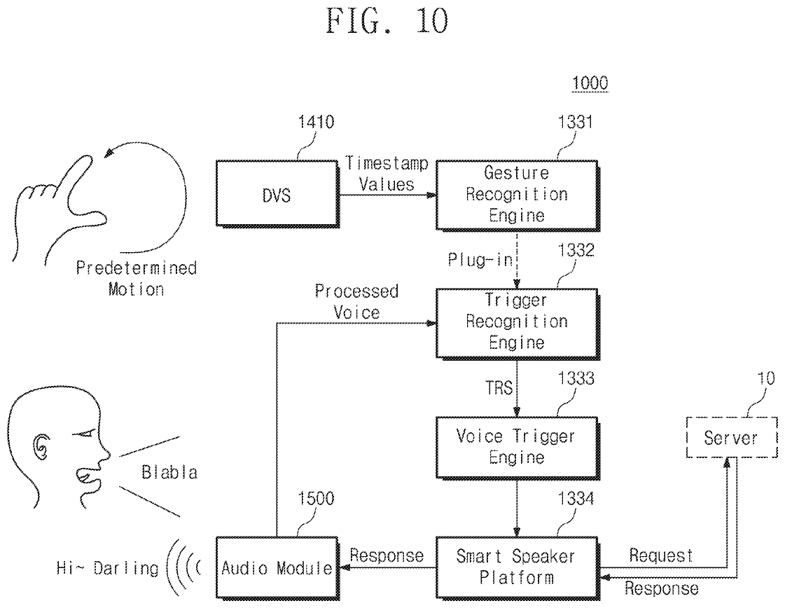

FIG. 10 illustrates an electronic device according to an exemplary embodiment of the present disclosure.

Unlike the exemplary embodiment of FIG. 7, the exemplary embodiment of FIG. 10 relates not only to a gesture, but also to providing a voice recognition service via voice. In an exemplary embodiment, when a voice recognition service requiring high-level security is to be provided, triggering by gesture recognition and triggering by voice recognition may be used simultaneously. Thus, in exemplary embodiments, security may be increased by requiring authentication via both gesture recognition and voice recognition rather than only via gesture recognition.

The triggering through gesture recognition is substantially the same as that described with reference to the exemplary embodiment of FIG. 7. Thus, for convenience of explanation, a further description of elements and processes previously described may be omitted. Even though the gesture recognition engine 1331 recognizes a specific gesture, the voice trigger engine 1333 may not operate immediately. For example, in an exemplary embodiment, both the user's gesture and the user's voice need to satisfy the trigger condition such that the trigger recognition engine 1332 may generate the trigger recognition signal TRS and the voice trigger engine 1333 may be triggered by the trigger recognition signal TRS. In such an exemplary embodiment, the voice trigger engine 1333 may not operate until the gesture recognition engine 1331 successfully recognizes the gesture.

The audio module 1500 may detect and process the voice of the user. The audio module 1500 may perform preprocessing on the voice of the user input through a microphone. For example, AEC (Acoustic Echo Cancellation), BF (Beam Forming), and NS (Noise Suppression) may be performed as preprocessing.

The preprocessed voice may be input into the trigger recognition engine 1332. The trigger recognition engine 1332 may determine whether the preprocessed voice satisfies the trigger recognition condition. For example, the trigger recognition engine 1332 determines whether the activation condition of the voice recognition service is satisfied, based on a specific word, the arrangement of specific words, etc. When both the gesture and voice of the user satisfy the trigger condition, the voice trigger engine 1333 may be triggered.

The voice trigger engine 1333 may trigger the specific command of the voice recognition service based on the smart speaker platform 1334 in response to the trigger recognition signal TRS. The server 10 may provide a response corresponding to the request to the electronic device 1000 in response to a request from electronic device 1000, and the smart speaker platform 1334 may provide the user with a message corresponding to the received response via the audio module 1500.

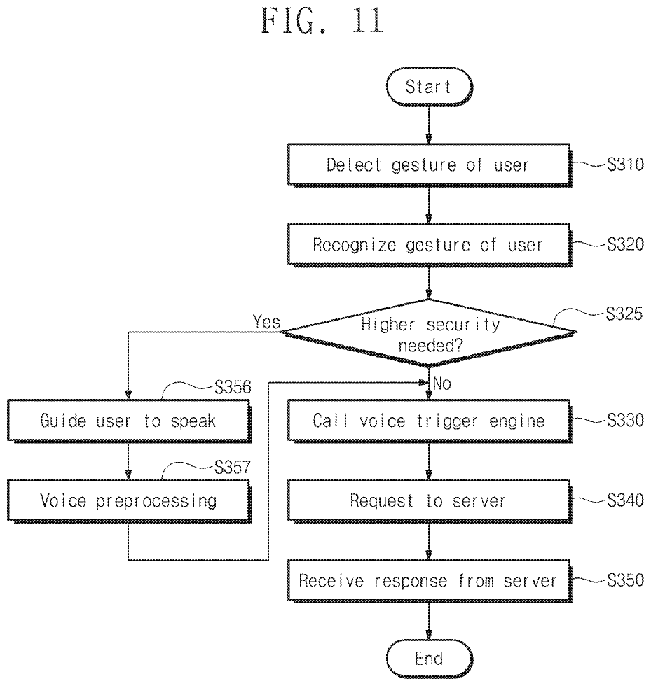

FIG. 11 is a flowchart illustrating a method of operating an electronic device according to an exemplary embodiment of the present disclosure. An exemplary embodiment of the present disclosure will be described hereinafter with reference to FIGS. 10 and 11.

In operation S310, the motion of the user may be detected. For example, the DVS 1410 may detect an event in which the intensity of light changes and may generate timestamp values corresponding to a time when the event occurs.

In operation S320, the gesture of the user may be detected. For example, the gesture recognition engine 1331 may recognize a user's specific gesture based on a specific change pattern, change direction, etc. of the received timestamp values, as described above. In an exemplary embodiment, even though the recognized gesture satisfies the trigger condition, the voice trigger engine 1333 may not yet be triggered. In FIG. 11, it is assumed that the gesture detected in operation S310 is determined to be a recognized gesture in operation S320.

In operation S325, it is determined whether the user's gesture is a gesture requiring the higher-level security. When the user's gesture does not require the higher-level security (No), the procedure of calling the voice trigger engine 1333 in operation S330, transmitting a request according to the gesture to the server 10 in operation S340, and receiving a response for providing a voice recognition service corresponding to the request of the user from the server 10 in operation S350 may be performed. Thus, in exemplary embodiments, the electronic device 1000 may perform a low-level security task based only on the user's gesture (e.g., without requiring the user's voice input), but may require both the user's gesture and the user's voice input to perform a high-level security task.

Alternatively, in operation S325, when the user's gesture requires the higher-level security (Yes), an additional operation may be required. For example, in operation S356, the middleware 1350 may guide the user to enter a voice through an electronic device at the request of the trigger recognition engine 1332. The guide may be, for example, a message, an image, etc. displayed on the display, or may be a voice.

In operation S357, the user may provide the voice depending on the guide provided through the electronic device, and preprocessing such as AEC, BF, NS, etc. may be performed by the audio module 1500. The subsequent procedures such as the calling of the voice trigger engine in operation S330, the transmitting of the request to the server in operation S340, and the receiving of the response from the server in operation S350 may be performed on the preprocessed voice.

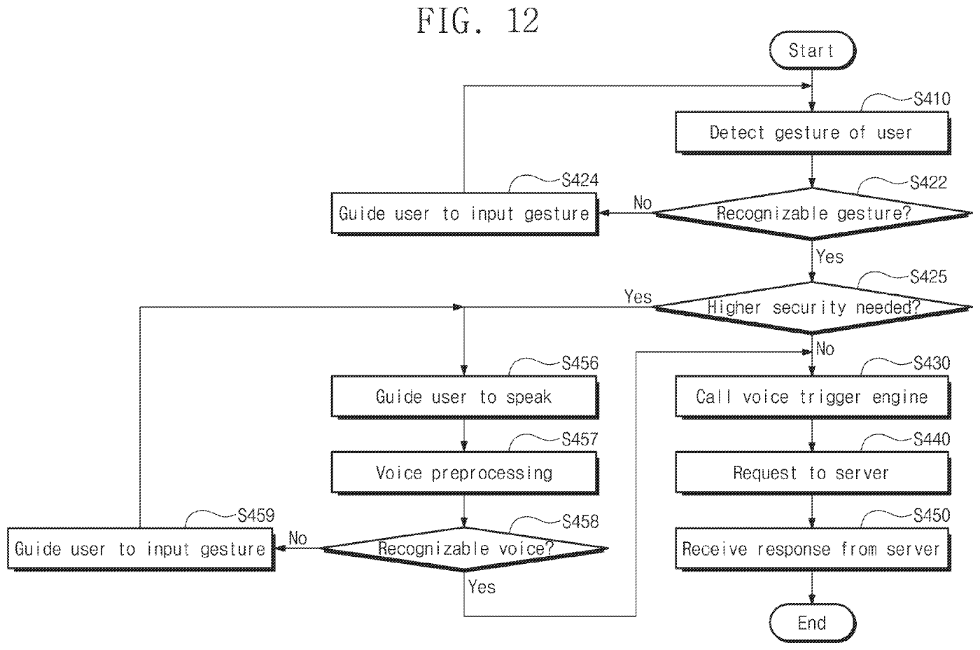

FIG. 12 is a flowchart illustrating a method of operating an electronic device according to an exemplary embodiment of the present disclosure. An exemplary embodiment of the present disclosure will be described hereinafter with reference to FIGS. 10 and 12.

In operation S410, the DVS 1410 detects an event in which the intensity of light changes according to the motion of the user, and the DVS 1410 generates timestamp values including information about a time at which the event occurs depending on the detection result.

In operation S422, the gesture recognition engine 1331 determines whether the detected gesture is a recognized/recognizable gesture capable of triggering the trigger recognition engine 1332. As described above, the gesture recognition engine 1331 may recognize a user's specific gesture based on a specific change pattern, change direction, change speed, etc. of the timestamp values. When the detected gesture is not a recognized/recognizable gesture capable of triggering the trigger recognition engine 1332 (No in operation S422), the trigger recognition engine 1332 may request the middleware 1350 of FIG. 2 to detect and recognize a gesture again. In operation S424, the middleware may guide the user to input a gesture again through an electronic device at the request of the trigger recognition engine 1332. The guide may be, for example, a message, an image, or a voice.

Alternatively, when the detected gesture is a recognized/recognizable gesture that triggers the trigger recognition engine 1332 (Yes in operation S422), in operation S425, it is determined whether the gesture of the user is a gesture requiring a higher-level security.

When the user's gesture does not require the higher-level security (No in operation S425), the procedure of calling the voice trigger engine 1333 in operation S430, transmitting a request according to the gesture to the server 10 in operation S440, and receiving a response for providing a voice recognition service corresponding to the request of the user from the server 10 in operation S450 may be performed.

Alternatively, when the user's gesture requires a higher-level security (Yes in operation S425), in operation S456, the middleware 1350 may guide the user to enter a voice through an electronic device. The guide may be a message or an image displayed on the display or may be a voice provided through a speaker. In operation S457, the user may provide the voice depending on the guide provided through the electronic device, and preprocessing such as AEC, BF, NS, etc. may be performed by the audio module 1500.

In operation S458, the trigger recognition engine 1332 determines whether the preprocessed voice is a recognizable voice capable of triggering the trigger recognition engine 1332. The trigger recognition engine 1332 determines whether the activation condition of the voice recognition service is satisfied based on, for example, a specific word, the arrangement of specific words, etc. When the recognized voice is not capable of triggering the trigger recognition engine 1332 (No in operation S458), in operation S459, the middleware 1350 of FIG. 2 may guide the user to input a voice again.

Alternatively, when the recognized voice is capable of triggering the trigger recognition engine 1332 (Yes in operation S458), that is, when both the gesture and voice of the user satisfy the trigger condition, in operation S430, the voice trigger engine 1333 may be triggered (or called). Afterward, the subsequent procedures such as the transmitting of the request to the server in operation S440 and the receiving of the response from the server in operation S450 may be performed.

According to the electronic devices described above, in exemplary embodiments, the voice trigger engine may be triggered by the detected gesture using the DVS. Accordingly, the amount of data necessary to trigger a voice recognition service may be reduced according to exemplary embodiment, as described above. Further, the security performance of the electronic device providing a voice recognition service may be improved by additionally requiring voice trigger recognition by the user's voice in some cases, as described above.

According to an exemplary embodiment of the present disclosure, a voice recognition service triggered by the gesture of a user is provided, in which the amount of data processed by the electronic device may be greatly reduced by sensing the user's gesture using a dynamic vision sensor.

Furthermore, according to an exemplary embodiment of the present disclosure, a voice recognition service triggered not only by the gesture of a user, but also by the voice of the user, is provided. The security of an electronic device additionally providing the voice recognition service may be improved by requiring the trigger by both the gesture and the voice of the user (e.g., by requiring the user to provide both a gesture input and a voice input to access high-security functionality).

As is traditional in the field of the present disclosure, exemplary embodiments are described, and illustrated in the drawings, in terms of functional blocks, units and/or modules.

Those skilled in the art will appreciate that these blocks, units and/or modules are physically implemented by electronic (or optical) circuits such as logic circuits, discrete components, microprocessors, hard-wired circuits, memory elements, wiring connections, etc., which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the exemplary embodiments may be physically separated into two or more interacting and discrete blocks, units and/or modules without departing from the scope of the present disclosure. Further, the blocks, units and/or modules of the exemplary embodiments may be physically combined into more complex blocks, units and/or modules without departing from the scope of the present disclosure.

While the present disclosure has been described with reference to the exemplary embodiments thereof, it will be apparent to those of ordinary skill in the art that various changes and modifications may be made thereto without departing from the spirit and scope of the present disclosure as set forth in the following claims.

What is claimed is:

1. An electronic device, comprising:
a memory storing a gesture recognition program and a voice trigger program;
a dynamic vision sensor configured to detect an event corresponding to a change of light caused by motion of an object;
a processor configured to execute the gesture recognition program to determine whether a gesture of the object is recognized based on timestamp values output from the dynamic vision sensor, and execute the voice trigger program in response to the gesture being recognized; and
a communication interface configured to transmit a request for a voice recognition service corresponding to the gesture to a server in response to the voice trigger program being executed.

2. The electronic device of claim 1, wherein the memory further stores a trigger recognition program, and the processor is further configured to:
execute the trigger recognition program to determine whether the gesture satisfies an activation condition of the voice recognition service.

3. The electronic device of claim 2, wherein the processor is further configured to:
execute the gesture recognition program again when the gesture does not satisfy the activation condition of the voice recognition service.

4. The electronic device of claim 2, wherein the voice trigger program includes the trigger recognition program.

5. The electronic device of claim 2, wherein the memory is a buffer memory, and the gesture recognition program, the voice trigger program and the trigger recognition program are loaded onto the buffer memory.

6. The electronic device of claim 2, further comprising:
an audio module configured to receive a voice and to perform preprocessing on the received voice,
wherein the processor is configured to execute the voice trigger program based on the preprocessed voice.

7. The electronic device of claim 6, wherein the audio module is configured to perform at least one of Acoustic Echo Cancellation (AEC), Beam Forming (BF), and Noise Suppression (NS) on the received voice.

8. The electronic device of claim 1, wherein the request is in a JavaScript Object Notation (JSON) format.

9. The electronic device of claim 1, wherein the communication interface is configured to receive a response from the server in response to the request for the voice recognition service, and the electronic device further comprises:
an audio module configured to output a voice corresponding to the response from the server.

10. A method of operating an electronic device, the method comprising:
detecting, by a dynamic vision sensor, an event corresponding to a change of light caused by motion of an object;
determining, by a processor, whether a gesture of the object is recognized based on timestamp values output from the dynamic vision sensor;
triggering, by the processor and in response to recognizing the gesture, a voice trigger program; and
transmitting, by a communication interface, a request for a voice recognition service corresponding to the gesture to a server in response to the voice trigger program being triggered.

11. The method of claim 10, further comprising:
determining, by a trigger recognition program executed by the processor, whether the gesture satisfies a first activation condition of the voice recognition service.

12. The method of claim 11, further comprising:
receiving, by an audio module, a voice;
performing preprocessing on the received voice; and
determining, by the trigger recognition program executed by the processor, whether the preprocessed voice satisfies a second activation condition of the voice recognition service.

13. The method of claim 12, wherein the voice trigger program is triggered when both the first activation condition and the second activation condition are satisfied.

14. The method of claim 11, wherein the request is in a JavaScript Object Notation (JSON) format.

15. The method of claim 11, further comprising:
receiving, by the communication interface, a response from the server in response to the request for the voice recognition service; and
outputting, by an audio module, a voice corresponding to the response from the server.

16. A computer program product comprising a computer-readable storage medium having program instructions embodied therewith, the program instructions executable by a processor to cause the processor to:
control a dynamic vision sensor configured to detect an event corresponding to a change of light caused by motion of an object;
determine whether a gesture of the object is recognized based on timestamp values output from the dynamic vision sensor;
execute a voice trigger program in response to the gesture being recognized; and
transmit a request for a voice recognition service corresponding to the gesture to a server in response to the voice trigger program being executed.

17. The computer program product of claim 16, wherein the program instructions executable by the processor further cause the processor to:
execute a trigger recognition program that determines whether the gesture satisfies an activation condition of the voice recognition service.

18. The computer program product of claim 17, wherein the program instructions executable by the processor further cause the processor to:
determine, again, whether the gesture of the object is recognized when the gesture does not satisfy the activation condition of the voice recognition service.

19. The computer program product of claim 17, wherein the program instructions executable by the processor further cause the processor to:
execute the voice trigger program based on a received voice.

20. The computer program product of claim 16, wherein the request is in a JavaScript Object Notation (JSON) format.
